(19) United States
(12) Patent Application Publication
(10) Pub. No.: US 2026/0003504 A1
(43) Pub. Date: Jan. 1, 2026

(54) Power Gating for Memory Physical Layers

(71) Applicant: Advanced Micro Devices, Inc., Santa Clara, CA (US)

(72) Inventors: Saurabh Bhandari, Bangalore (IN); Manjunath D. Haritsa, Cupertino, CA (US); Sandeep Prajapati, Bangalore (IN); Srinivas Sriadibatla, Bangalore (IN)

(73) Assignee: Advanced Micro Devices, Inc., Santa Clara, CA (US)

(21) Appl. No.: 18/758,387

(22) Filed: Jun. 28, 2024

(51) Int. Cl. G06F 3/06

(52) U.S. Cl. CPC G06F 3/0611; G06F 3/0634; G06F 3/0673

(57) ABSTRACT

In accordance with the described techniques, a device includes a host processor, a memory, and a memory physical layer. The memory physical layer enters an enhanced low power state in which a power supply is disconnected from a portion of the memory physical layer while the memory is inactive with respect to servicing memory requests of the host processor. In addition, the memory physical layer exits the enhanced low power state responsive to the memory being active with respect to servicing memory requests of the host processor and/or at least one memory request being enqueued for servicing by the memory.

### BACKGROUND

In various computer architectures, a host processor accesses data from external memory sources. Memory physical layers (PHYs) are leveraged to facilitate data transfer between the external memory sources and the host processor. In particular, memory PHYs manage the physical aspects of data transmission, such as signal conditioning, timing of signal transmission, voltage scaling and power management, and so on.

### BRIEF DESCRIPTION OF THE DRAWINGS

FIG. 1 is a block diagram of a non-limiting example system to implement power gating for memory physical layers.

FIG. 2 depicts a non-limiting example system showing operation of a memory physical layer entering an enhanced low power state.

FIG. 3 depicts a non-limiting example system showing operation of a memory physical layer exiting an enhanced low power state.

FIG. 4 depicts a procedure in an example implementation of power gating for memory physical layers.

### DETAILED DESCRIPTION

### Overview

A device (e.g., a computing device, such as a smartphone or a laptop computer) includes a host processor communicatively coupled to a memory module. The host processor includes a core having one or more caches, a memory controller, control logic, and a voltage regulator, while the memory module includes a memory. The device also includes a memory physical layer (PHY) sitting partially in the host processor and partially in the memory module. The host processor is configured to access data from the one or more caches and from the memory. Since the caches are closer (in terms of data communication pathways) and faster (in terms of data access speed), the host processor accesses data from the caches whenever the requested data is available in the caches. If, however, data requested by a memory request (e.g., a read request or a write request) is not available in the caches, the host processor accesses the data from the memory. Accordingly, the device experiences phases in which the host processor is not accessing data from the memory, e.g., the host processor is instead accessing data from the caches. During these phases, the memory and the memory PHY are inactive with respect to servicing memory requests, and a substantial portion of the memory PHY is not in use.

Accordingly, techniques are described herein to disconnect a power supply from a portion of the memory PHY during phases in which the memory is not servicing memory requests. In accordance with the described techniques, the voltage regulator is configured to provide a power supply to the memory PHY via a gated connection and an always on connection. The gated connection is capable of being disconnected while the device is powered up, while the always on connection continuously supplies power to the memory PHY while the device is powered up.

In response to detecting that the memory is inactive with respect to servicing memory requests and there are no memory requests enqueued in pending memory request queues of the memory controller, the control logic issues a disengagement signal. The disengagement signal prompts generation and disbursement of save signals within the memory PHY, which causes registers (or portions thereof) to save a current state of data within the memory PHY. The registers are connected to the power supply via the always on connection. After the data is saved to the registers, the voltage regulator disconnects the power supply via the gated connection, which supplies power to the remainder of the memory PHY. In other words, the memory PHY operates in an enhanced low power state in which the power supply is disconnected from the portion of the memory PHY while the memory is inactive with respect to servicing memory requests and there are no memory requests enqueued for servicing by the memory.

While the memory is in the enhanced low power state, the control logic detects that the memory is transitioning to an active state with respect to servicing memory requests, and issues an engagement signal. The engagement signal indicates that at least one memory request is being serviced by the memory and/or at least one memory request is enqueued in pending memory request queues of the memory controller. Further, the engagement signal causes the voltage regulator to connect the power supply to the memory PHY via the gated connection. In addition, the engagement signal prompts generation and disbursement of restore signals within the memory PHY, which causes registers (or portions thereof) to restore the current state of the data to corresponding portions of the memory PHY. Once restored, the memory PHY is able to resume operating in an active state in which the memory PHY manages the physical aspects of data transmission for the memory requests to be serviced.

Conventional techniques for power management within the memory PHY implement clock gating. This involves disabling the clock signal to the memory PHY (or portions thereof) during periods of memory PHY inactivity. However, the power supply of a conventionally configured device is connected to the memory PHY (e.g., the memory PHY is on) at all times when the device is on/powered up. In contrast, the described techniques implement power gating by disconnecting the power supply from a portion of the memory PHY during periods of memory PHY inactivity. Power gating significantly reduces leakage power in the memory PHY as compared to clock gating, and as such, the described techniques extend battery life for the device as compared to conventional techniques. Moreover, the described techniques safely transition into and out of the enhanced low power state with minimal latency through saving and restoring the current state of the data in the manner described.

In some aspects, the described techniques relate to a device, comprising a host processor, a memory, and a memory physical layer configured to enter an enhanced low power state in which a power supply is disconnected from a portion of the memory physical layer while the memory is inactive with respect to servicing memory requests of the host processor.

In some aspects, the described techniques relate to a device, wherein the memory physical layer is configured to enter the enhanced low power state responsive to no memory requests being serviced by the memory and no memory requests being enqueued for servicing by the memory.

In some aspects, the described techniques relate to a device, wherein the memory physical layer is further configured to exit the enhanced low power state responsive to at least one memory request being serviced by the memory.

In some aspects, the described techniques relate to a device, wherein the memory physical layer is configured to exit the enhanced low power state responsive to at least one memory request being enqueued for servicing by the memory.

In some aspects, the described techniques relate to a device, wherein the power supply is disconnected from one or more input/output (I/O) interfaces of the memory physical layer while the memory physical layer operates in the enhanced low power state, thereby causing the memory to operate in a self-refresh mode.

In some aspects, the described techniques relate to a device, wherein the memory physical layer includes registers storing a current state of data within the memory physical layer, and the power supply is connected to the registers while the memory physical layer operates in the enhanced low power state.

In some aspects, the described techniques relate to a device, wherein one or more registers of the registers are implemented in retention flops each including a retention cell and an operation cell, and the power supply is connected to the retention cells and disconnected from the operation cells while the memory physical layer operates in the enhanced low power state.

In some aspects, the described techniques relate to a device, wherein the memory physical layer is configured to issue one or more save signals causing the one or more registers to save the current state of the data to the retention cells prior to entering the enhanced low power state.

In some aspects, the described techniques relate to a device, wherein the memory physical layer is configured to issue one or more restore signals causing the one or more registers to restore the current state of the data to the operation cells responsive to exiting the enhanced low power state.

In some aspects, the described techniques relate to a device, wherein one or more registers of the registers are implemented in static random access memory of the memory physical layer, and the power supply is connected to the static random access memory while the memory physical layer operates in the enhanced low power state.

In some aspects, the described techniques relate to a device, wherein the memory physical layer is configured to issue one or more save signals causing the one or more registers to save the current state of the data to the static random access memory prior to entering the enhanced low power state.

In some aspects, the described techniques relate to a device, wherein the memory physical layer is configured to issue one or more restore signals causing the one or more registers to restore, responsive to exiting the enhanced low power state, the current state of the data to the portion of the memory physical layer to which the power supply is disconnected while the memory physical layer operates in the enhanced low power state.

In some aspects, the described techniques relate to a system, comprising a memory, a memory physical layer, and a host processor configured to issue a disengagement signal indicating that the memory is inactive with respect to servicing memory requests of the host processor, the disengagement signal causing the memory physical layer to enter an enhanced low power state in which a power supply is disconnected from a portion of the memory physical layer.

In some aspects, the described techniques relate to a system, wherein the disengagement signal indicates that there are no memory requests being serviced by the memory and there are no memory requests enqueued for servicing by the memory.

In some aspects, the described techniques relate to a system, wherein the host processor is further configured to issue an engagement signal indicating that at least one memory request is being serviced by the memory and/or at least one memory request is enqueued for servicing by the memory, the engagement signal causing the memory physical layer to exit the enhanced low power state.

In some aspects, the described techniques relate to a system, wherein the memory physical layer includes registers storing a current state of data within the memory physical layer, and the power supply is connected to the registers while the memory physical layer operates in the enhanced low power state.

In some aspects, the described techniques relate to an apparatus, comprising a host processor, a memory, a memory physical layer, and a voltage regulation circuitry configured to disconnect a power supply from a portion of the memory physical layer while the memory is inactive with respect to servicing memory requests of the host processor.

In some aspects, the described techniques relate to an apparatus, wherein the voltage regulation circuitry is configured to disconnect the power supply from the portion of the memory responsive to no memory requests being serviced by the memory and no memory requests being enqueued for servicing by the memory.

In some aspects, the described techniques relate to an apparatus, wherein the voltage regulation circuitry is configured to connect the power supply to the portion of the memory physical layer responsive to at least one memory request being serviced by the memory and/or at least one memory request enqueued for servicing by the memory.

In some aspects, the described techniques relate to an apparatus, wherein the memory physical layer includes registers storing a current state of data within the memory physical layer, and the power supply is connected to the registers while the power supply is disconnected from the portion of the memory physical layer.

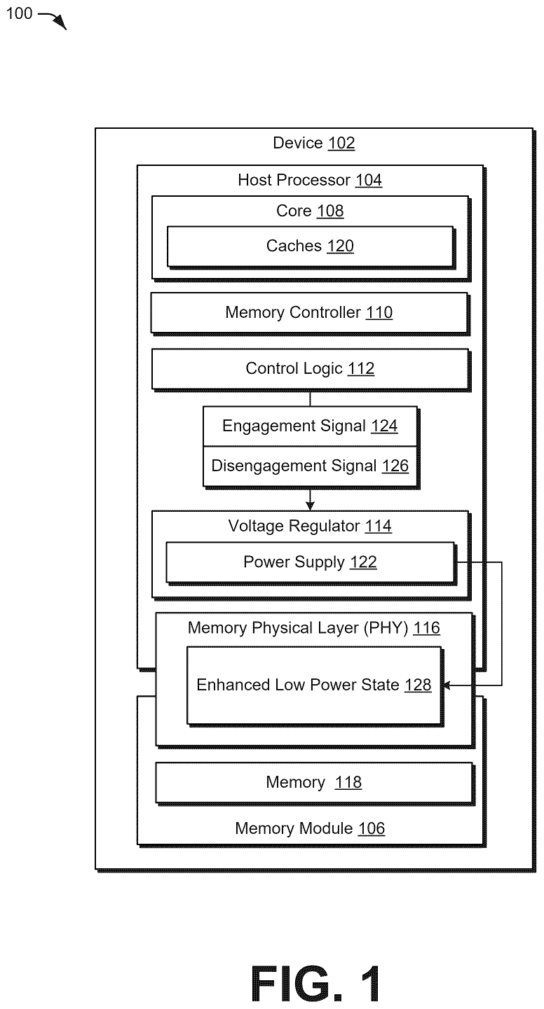

FIG. 1 is a block diagram of a non-limiting example system 100 to implement power gating for memory physical layers. The system 100 includes a device 102 having a host processor 104 and a memory module 106. The host processor includes a core 108, a memory controller 110, control logic 112, and a voltage regulator 114, while the memory module 106 includes a memory 118. Further, the device 102 includes a memory physical layer (PHY) 116 that sits partially within the host processor 104 and partially within the memory module 106.

In accordance with the described techniques, the host processor 104 and the memory module 106 are coupled to one another via one or more wired connections. Example wired connections include, but are not limited to, buses (e.g., a data bus), interconnects, traces, and planes. Examples of the device 102 include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host processor 104 is an electronic circuit that performs various operations on and/or using data in the memory 118. Examples of the host processor 104 and/or the core 108 include, but are not limited to, a central processing unit (CPU), a graphics processing unit (GPU), an application specific integrated circuit (ASIC), and a field programmable gate array (FPGA). For example, the core 108 is a processing unit that reads and executes requests and/or instructions (e.g., of software programs), examples of which include to add data, to move data, and to branch. Although one core 108 is depicted in the example system 100, the host processor 104 includes more than one core 108 in variations, e.g., the host processor 104 is a multi-core processor.

In one or more implementations, the memory module 106 is a circuit board (e.g., a printed circuit board), on which the memory 118 is mounted and includes a portion of the memory PHY 116. Examples of the memory module 106 include, but are not limited to, a TransFlash memory module, a single in-line memory module (SIMM), and a dual in-line memory module (DIMM). In one or more implementations, the memory module 106 is a single integrated circuit device that incorporates the memory 118 and the portion of the memory PHY 116 on a single chip. In some examples, the memory module 106 is composed of multiple chips that implement the memory 118 and the portion of the memory PHY 116, and the multiple chips are vertically (“3D”) stacked together, are placed side-by-side on an interposer or substrate, or are assembled via a combination of vertical stacking or side-by-side placement.

The memory 118 is a device or system that is used to store information, such as for immediate use in a device, e.g., by the core 108 of the host processor 104. In one or more implementations, the memory 118 corresponds to semiconductor memory where data is stored within memory cells on one or more integrated circuits. In at least one example, the memory 118 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 118 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memory 118 is configurable in a variety of ways that support power gating for memory physical layers.

The memory controller 110 and the memory PHY 116 are electronic circuits that work in conjunction to manage the flow of data between the core 108 and the memory 118. By way of example, the memory controller 110 and the memory PHY 116 are representative of functionality for reading data from the memory 118 and writing data to the memory 118. The memory controller 110 handles the logical aspects of memory access, such as decoding memory addresses of memory requests, managing data pathways (e.g., data buses) between the core 108 and the memory module 106, and so on.

The memory PHY 116, on the other hand, manages the physical aspects of data transmission, such as signal conditioning, timing of signal transmission, voltage scaling and power management, and so on. Examples of the memory PHY 116 include, but are not limited to, a double date rate memory physical layer (DDR PHY), a low power double data rate memory physical layer (LPDDR PHY), a graphics double data rate memory physical layer (GDDR PHY), a high bandwidth memory physical layer (HBM PHY), a synchronous dynamic random access memory physical layer (SDRAM PHY), and a reduced latency dynamic random access memory physical layer (RLDRAM PHY), to name a few.

As shown, the core 108 includes one or more caches 120 where data is stored. By way of example, the core 108 includes a cache hierarchy, and the caches 120 include level 1 (L1) cache(s), level 2 (L2) cache(s), and a level (L3) cache. To process a memory request (e.g., a read request or write request), the core 108 checks whether the requested data is present in the caches 120. If the caches 120 include the requested data, the core 108 accesses the data of the memory address in the caches 120, rather than the memory 118. This is because the caches 120 are closer (in terms of data communication pathways) and faster (in terms of data access speed) than the memory 118. If, however, the requested data is not present in the caches 120, the memory request is forwarded to the memory controller 110, which works in conjunction with the memory PHY 116 to access the requested data in the memory 118.

In other words, the device 102 experiences phases in which the host processor 104 is accessing data from the memory 118. In these phases, the memory 118 and the memory PHY 116 are active (e.g., in an active state) with respect to servicing memory requests. Further, the device 102 experiences phases in which the host processor 104 is not accessing data from the memory 118, e.g., the host processor 104 is accessing data from the caches 120 rather than the memory 118. In these phases, the memory 118 and the memory PHY 116 are inactive (e.g., in an idle state) with respect to servicing memory requests, and a majority of the memory PHY 116 is not being used. During these phases, the majority of the memory PHY 116 that is not being used does not need to be powered up to preserve functionally correct data access and execution. As used herein, the memory 118 and the memory PHY 116 are considered “inactive” when there are no memory requests being serviced by the memory 118 and there are no memory requests enqueued for servicing by the memory 118.

Accordingly, techniques are described herein to disconnect a power supply from a portion of the memory PHY 116 during phases in which the memory 118 is in the idle state. As part of this, the device 102 employs the control logic 112 which is an electronic circuit that detects whether the memory 118 is inactive with respect to servicing memory requests. Any one or more of a variety of memory activity detection techniques are usable by the control logic 112 to determine whether the memory 118 is in an idle state, including but not limited to monitoring memory requests dispatched from the memory controller 110, monitoring data paths (e.g., data bus activity) between the memory module 106 and the host processor 104, monitoring pending memory request queues of the memory controller 110, and so on.

In accordance with the described techniques, the control logic 112 is configured to communicate engagement signals 124 to the voltage regulator 114 indicating when the memory 118 transitions from an idle state to an active state. While the memory 118 is in an idle state, for example, the control logic 112 communicates an engagement signal 124 responsive to a memory request having been dispatched by the memory controller 110 to the memory module 106 and/or a memory request having been enqueued in a pending memory request queue of the memory controller 110.

Furthermore, the control logic 112 is configured to communicate disengagement signals 126 to the voltage regulator 114 indicating when the memory 118 transitions from an active state to an idle state. While the memory 118 is in the active state, for example, the control logic 112 communicates a disengagement signal 126 responsive to all memory requests dispatched to the memory module 106 having completed and pending memory request queues of the memory controller 110 having been emptied. Notably, a read request completes when the requested data has been read and communicated back to the memory controller 110, while a write request completes when the data has been written to the requested location in the memory 118.

As shown, the voltage regulator 114 is an electronic circuit that provides a power supply 122 of constant voltage (e.g., 0.75 volts) to the memory PHY 116. By way of example, a power source (e.g., a battery of the device 102, an external battery, an alternating current (AC) adapter such as a wall outlet, a docking station, a port replicator, and the like) provides power to hardware components of the device 102. Further, the voltage regulator 114 receives an input voltage from the power source (which changes with time), and supplies a power supply 122 (of constant voltage) to the memory PHY 116. In variations, the voltage regulator 114 is an on-die voltage regulator integrated in a same semiconductor die that implements the host processor 104, or the voltage regulator 114 is located external to the semiconductor die that implements the host processor 104. In one or more implementations, the voltage regulator 114 is a low-dropout voltage regulator. Although depicted and described herein as part of the host processor 104, it is to be appreciated that the control logic 112 and/or the voltage regulator 114 are part of the memory module 106, in variations.

In accordance with the described techniques, the voltage regulator 114 is configured to disconnect the power supply 122 from a portion of the memory PHY 116 while the memory 118 is in the idle state. To do so, the voltage regulator 114 disconnects the power supply 122 from the portion of the memory PHY 116 responsive to receiving a disengagement signal 126 from the control logic 112, thereby causing the memory PHY 116 to enter an enhanced low power state 128.

Furthermore, the voltage regulator 114 is configured to connect the power supply 122 to the portion of the memory PHY 116 while the memory 118 is in the active state. To do so, the voltage regulator 114 connects the power supply 122 to the portion of the memory PHY 116 responsive to receiving an engagement signal 124 from the control logic 112, thereby causing the memory PHY 116 to exit the enhanced low power state 128.

As previously mentioned, the memory PHY 116 sits partially within the host processor 104 and partially within the memory module 106. In one or more implementations, the portion of the memory PHY 116 that is capable of disconnecting from the power supply 122 corresponds to a portion of the memory PHY 116 that sits within the host processor 104. Additionally or alternatively, the portion of the memory PHY 116 that is capable of disconnecting from the power supply 122 corresponds to a portion of the memory PHY 116 that sits within the host processor 104 and the memory module 106.

Conventional memory PHY power management techniques implement clock gating. Clock gating the memory PHY 116 involves disabling the clock signal to the memory PHY 116 (or portions thereof) during phases in which the memory 118 and the memory PHY 116 are inactive. However, the power supply 122 of a conventionally configured device is connected to the memory PHY 116 (e.g., the memory PHY 116 is powered up) at all times when the device is on/powered up. In contrast, the described techniques implement power gating for the memory PHY 116 by disconnecting the power supply 122 from the majority of the memory PHY 116 that is not in use while the memory 118 is not servicing memory requests. Power gating significantly reduces leakage power in the memory PHY 116 as compared to clock gating, and as such, the described techniques extend battery life for the device 102 as compared to conventional techniques.

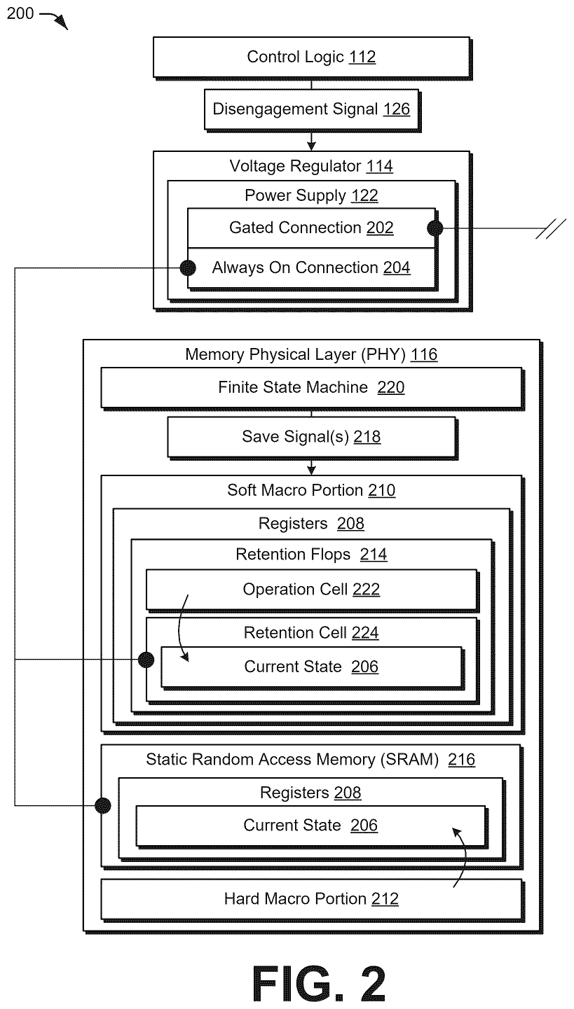

FIG. 2 depicts a non-limiting example system 200 showing operation of a memory physical layer entering an enhanced low power state. In accordance with the described techniques, the control logic 112 issues a disengagement signal 126 to the voltage regulator 114 indicating that there are no memory requests being serviced by the memory 118 and there are no memory requests enqueued for servicing by the memory 118, e.g., the memory 118 is transitioning from an active state to an idle state. By way of example, the control logic 112 issues the disengagement signal 126 based on an absence of in-flight memory requests (e.g., an absence of memory requests that have been dispatched by the memory controller 110 but are incomplete) and pending memory request queues of the memory controller 110 having been emptied.

As shown, the voltage regulator 114 includes a gated connection 202 of the power supply 122 to the memory PHY 116, as well as an always on connection 204 of the power supply 122 to the memory PHY 116. The gated connection 202 is capable of being disconnected while the device 102 is powered up based on whether the memory 118 is in an active state or an idle state. To facilitate this, the gated connection 202 includes a gating mechanism (e.g., a transistor switch) to control (e.g., turn on and off) the flow of current to the portion of the memory PHY 116 to which the gated connection 202 is connected. In contrast, the always on connection 204 continuously provides the power supply 122 (e.g., at all times while the device 102 is powered up) to the portion of the memory PHY 116 to which the always on connection 204 is connected, e.g., regardless of the whether the memory 118 is in an idle state or an active state.

Broadly, the voltage regulator 114 is configured to disconnect the gated connection 202 from a portion of the memory PHY 116 responsive to receiving the disengagement signal 126. This causes the memory PHY 116 to operate in the enhanced low power state 128 (e.g., a power-gated state). In the enhanced low power state 128, the voltage regulator 114 continues to provide the power supply 122 to an additional portion of the memory PHY 116 via the always on connection 204, as shown.

It should be noted that, in order to preserve proper functioning of the memory PHY 116 and, in turn, functionally correct data access and execution for the device 102, the enhanced low power state 128 is to be safely entered. To do so, the memory PHY 116 saves the current state 206 of data operated on by the memory PHY 116 prior to entering the enhanced low power state 128. The current state 206 of the data refers to a configuration of the memory PHY 116 (e.g., including operational parameters, configuration settings, data temporarily stored within the memory PHY 116, status flags, and the like) at a moment in time immediately prior to entering the enhanced low power state 128. In particular, the current state 206 of the data is saved to registers 208 (or portions thereof) that are provided the power supply 122 via the always on connection 204. The registers 208 are electronic circuits that temporarily store data, and are accessible by the memory PHY 116 relatively faster than other data storage sources, e.g., the memory 118. In one or more examples, the registers 208 are control and status registers.

By saving the current state 206 to the registers 208 in the manner described, the current state 206 of the data operated on by the memory PHY 116 is preserved when the power supply 122 is disconnected from the remainder of the memory PHY 116. This enables the current state 206 to be restored in an efficient manner when the memory PHY 116 exits the enhanced low power state 128 and enters an active state. It is to be appreciated that, in addition to the current state 206 of the data within the memory PHY 116, the registers 208 save additional information relating to the current state of the memory PHY 116, including but not limited to, configuration settings, error statuses, and an operational mode of the memory PHY 116.

In accordance with very large scale integration (VLSI) designs, the memory PHY 116 includes a soft macro portion 210 and a hard macro portion 212. The hard macro portion 212 includes functional blocks of the memory PHY 116 that are only modifiable via changes at the physical layout level. In contrast, the soft macro portion 210 includes parameterized and synthesizable representations of functional blocks having digital logic described at the register-transfer level (RTL), as opposed to the physical layout level. Generally, the soft macro portion 210 offers increased flexibility with respect to design modification, as compared to the hard macro portion 212.

As shown, one or more of the registers 208 are implemented in retention flops 214 of the soft macro portion 210 to save the current state 206 of the data within the soft macro portion 210 of the memory PHY 116. Additionally or alternatively, one or more of the registers 208 are implemented in static random access memory (SRAM) 216 of the memory PHY 116 to save the current state 206 of the data within the hard macro portion 212 of the memory PHY 116. Although depicted and described herein as SRAM 216, it is to be appreciated that other types of memory are usable to store the current state 206 of the data of the hard macro portion 212 of the memory PHY 116 without departing from the spirit or scope of the described techniques, e.g., RAM, DRAM, and SDRAM.

In accordance with the described techniques, one or more save signals 218 are generated (internally within the memory PHY 116) to facilitate saving of the current state 206 of the data to the registers 208 (or portions thereof) that receive the power supply 122 via the always on connection 204. By way of example, the disengagement signal 126 is additionally communicated to a finite state machine 220 of the memory PHY 116. The finite state machine 220, for instance, is a computational model defining and describing states of the memory PHY 116 (e.g., the active state and the enhanced low power state 128) and conditions for transitioning between these states. Here, the finite state machine 220 receives the disengagement signal 126, which prompts entrance of the enhanced low power state 128, e.g., transitioning of the memory PHY 116 from the active state to the enhanced low power state 128.

In response to receiving the disengagement signal 126, the finite state machine 220 issues the one or more save signals 218, which are provided to the retention flops 214. The retention flops 214 are storage mechanisms of the registers 208 implemented in electronic circuitry (e.g., latches and/or flip flops) and each include an operation cell 222 and a retention cell 224. The operation cell 222, for example, is a flip flop that stores binary data used by the memory PHY 116 while the memory PHY 116 is in the active state. The retention cell 224, for example, is a latch where the data of the operation cell 222 is saved when the memory PHY 116 is in the enhanced low power state 128. As shown, the operation cells 222 are connected to the power supply 122 via the gated connection 202, while the retention cells 224 are connected to the power supply 122 via the always on connection 204.

Given this, the save signals 218 cause the registers 208 of the retention flops 214 to write the current state 206 of the data within the soft macro portion 210 from the operation cells 222 to the retention cells 224. In addition, the save signals 218 are provided to the hard macro portion 212, and cause the hard macro portion 212 to write the current state 206 of the data within the hard macro portion 212 to the registers 208 of the SRAM 216.

Once the data is saved to the registers 208 (or portions thereof) that receive the power supply 122 via the always on connection 204, the voltage regulator 114 disconnects the gated connection 202. In one or more implementations, the gated connection 202 powers the entirety of the memory PHY 116 except for the SRAM 216 and the retention cells 224. Thus, disconnecting the gated connection 202 disconnects the power supply 122 from the entirety of the memory PHY 116 except for the SRAM 216 and the retention cells 224. Additionally or alternatively, the gated connection 202 powers the entirety of the portion of the memory PHY 116 sitting within the host processor 104 except for the SRAM 216 and the retention cells 224. Thus, disconnecting the gated connection 202 disconnects the power supply 122 from the entirety of the portion of the memory PHY 116 sitting within the host processor 104 except for the SRAM 216 and the retention cells 224.

As part of this, the power supply 122 is disconnected from one or more input/output (I/O) interfaces of the memory PHY 116. The I/O interfaces of the memory PHY 116 are implemented in electronic circuitry of the memory PHY 116 and facilitate communication of data between the core 108 and the memory 118. This includes transmitting and receiving data signals over the communication interface according to the protocol implemented by the memory PHY 116, e.g., DDR, LPDDR, GDDR, etc. Disconnecting the power supply 122 from the I/O interfaces causes the memory 118 to operate in a self-refresh mode. Notably, DRAM stores data in the form of electrical charges. In order to maintain this data, the data is periodically refreshed, e.g., read and immediately written back without modification. In various implementation scenarios, the DRAM relies on external commands (e.g., from the memory controller 110) to facilitate periodic refreshing. In self-refresh mode, contrarily, the DRAM performs the periodic refreshing without relying on these external commands, which reduces power consumption by the DRAM. In examples in which the memory 118 includes or corresponds to DRAM, therefore, the enhanced low power state 128 further reduces power consumption for the device 102 by placing the memory 118 into a self-refresh mode.

In one or more implementations, the control logic 112 controls when to enter the enhanced low power state 128 based on an amount of time during which the memory 118 is predicted to be inactive with respect to servicing memory requests of the host processor 104. Upon detecting inactivity of the memory 118, for instance, the control logic 112 further predicts an amount of time that the memory will be inactive, e.g., based on previous memory access patterns. If the predicted amount of time is less than a known latency to enter and exit the enhanced low power state 128 (e.g., a combined entrance and exit latency), then the control logic 112 does not issue the disengagement signal 126 despite detecting inactivity of the memory 118. This causes the memory PHY 116 to remain in an active state. If, however, the predicted amount of time exceeds the combined entrance and exit latency, then the control logic 112 issues the disengagement signal 126 which causes the memory PHY 116 to enter the enhanced low power state 128. By doing so, the described techniques prevent situations in which the host processor 104 waits for the memory PHY 116 to power up before fetching data from the memory 118.

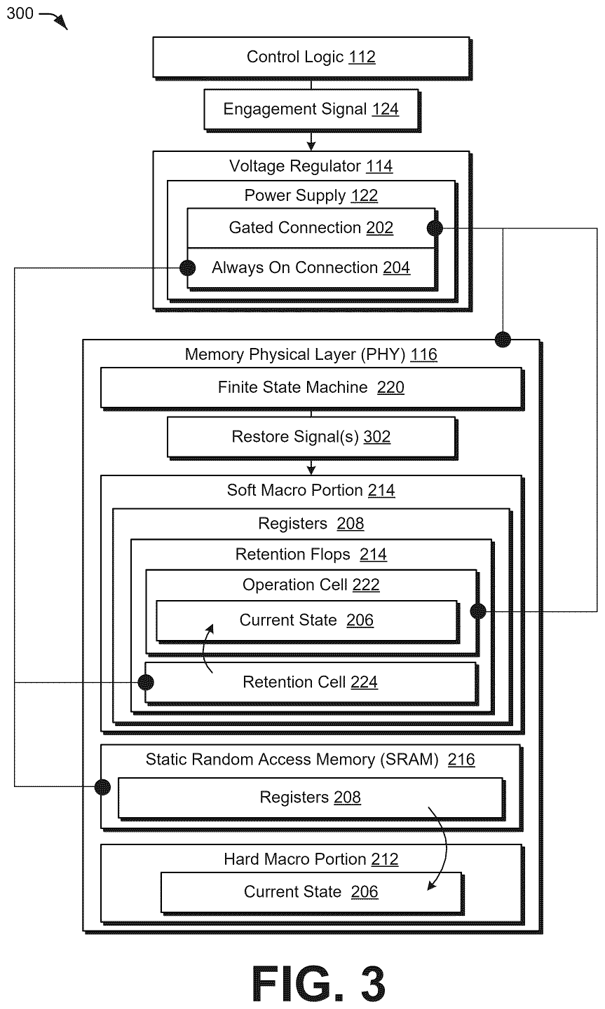

FIG. 3 depicts a non-limiting example system 300 showing operation of a memory physical layer exiting an enhanced low power state. In accordance with the described techniques, the control logic 112 issues an engagement signal 124 to the voltage regulator 114 indicating that at least one memory request is being serviced by the memory 118 and/or at least one memory request is enqueued for servicing by the memory 118. By way of example, the control logic 112 issues the engagement signal 124 based on the existence of at least one in-flight memory request (e.g., a memory request that has been dispatched by the memory controller 110 but is incomplete) and/or at least one memory request being enqueued in pending memory request queues of the memory controller 110.

Broadly, the voltage regulator 114 is configured to connect the gated connection 202 to a portion of the memory PHY 116 responsive to receiving the engagement signal 124. This causes the memory PHY 116 to exit the enhanced low power state 128 and enter the active state. In the active state, the voltage regulator 114 continues to provide the power supply 122 to the retention cells 224 and the SRAM 216.

More specifically, the voltage regulator 114 connects the gated connection 202 to the remainder of the memory PHY 116 (e.g., the entirety of the memory PHY 116 except for the SRAM 216 and the retention cells 224, or the entirety of the portion of the memory PHY 116 sitting within the host processor 104 except for the SRAM 216 and the retention cells 224), as shown. As part of this, the voltage regulator 114 connects the power supply 122 to the operation cells 222 via the gated connection 202.

While in the active state, the memory PHY 116 is able to perform its dedicated functionality of managing the physical aspects of data transmission for memory requests issued by the host processor 104. In various examples, the memory PHY 116 uses the current state 206 of the memory PHY 116 to resume processes that were paused when the enhanced low power state 128 was entered. Additionally or alternatively, the memory PHY 116 uses the current state 206 of the memory PHY 116 to begin new processes for facilitating data transfer of the newly received or newly enqueued memory requests that prompted exiting the enhanced low power state 128.

Additionally, the finite state machine 220 receives the engagement signal 124, which marks transitioning of the memory PHY 116 from the enhanced low power state 128 to the active state. In response to receiving the engagement signal 124, the finite state machine 220 issues one or more restore signals 302 to the retention flops 214 and the SRAM 216. The restore signals 302 cause the registers 208 of the retention flops 214 to write the current state 206 of the data within the soft macro portion 210 of the memory PHY 116 from the retention cells 224 to the operation cells 222 after the power supply 122 is connected to the operation cells 222 via the gated connection 202. In addition, the restore signals 302 cause the current state 206 of the data within the hard macro portion 212 to be written from the registers 208 of the SRAM 216 to the hard macro portion 212 after the power supply 122 is connected to the hard macro portion 212 via the gated connection 202.

By saving and restoring the current state 206 of the memory PHY 116 in the manner described, the described techniques preserve data integrity in the memory PHY 116, which enables proper functioning of the memory PHY 116 with minimal latency transitioning in and out of the enhanced low power state 128. Moreover, this is done while significantly reducing power leakage in the memory PHY 116 in comparison to conventional memory PHY power management techniques.

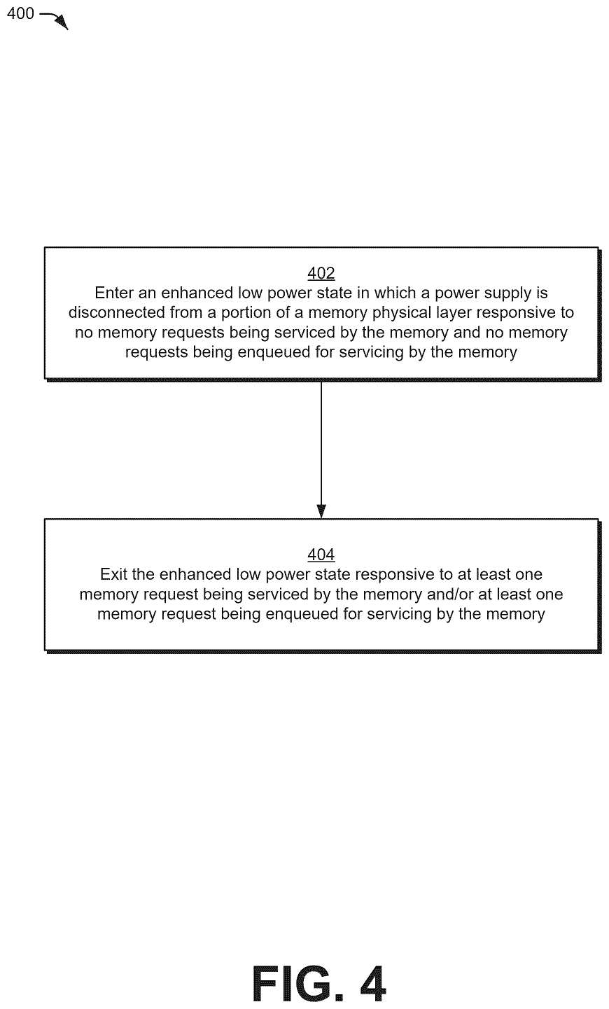

FIG. 4 depicts a procedure 400 in an example implementation of power gating for memory physical layers. In the procedure 400, an enhanced low power state is entered in which a power supply is disconnected from a portion of a memory physical layer responsive to no memory requests being serviced by the memory and no memory requests enqueued for servicing by the memory (block 402). By way of example, the control logic 112 detects that the memory 118 is inactive with respect to servicing memory requests of the host processor 104 based on an absence of in-flight memory requests and pending memory request queues of the memory controller 110 having been emptied. Responsive to this detection, the control logic 112 issues a disengagement signal 126.

The finite state machine 220 receives the disengagement signal 126, prompting the finite state machine 220 to issue one or more save signals 218. In particular, the save signals 218 are provided to the retention flops 214, which cause the retention flops 214 to write the current state 206 of the data within the soft macro portion 210 of the memory PHY 116 to the retention cells 224. In addition, the save signals 218 are provided to the hard macro portion 212, which causes the hard macro portion 212 to write the current state 206 of the data within the hard macro portion 212 to the SRAM 216. Notably, the retention cells 224 and the SRAM 216 are provided the power supply 122 via the always on connection 204. After the current state 206 of the data within the memory PHY 116 is saved, the voltage regulator 114 disconnects the power supply 122 from the remainder of the memory PHY 116 via the gated connection 202. This causes the memory PHY 116 to enter the enhanced low power state 128.

Moreover, the enhanced low power state is exited responsive to at least one memory request being serviced by the memory and/or at least one memory request being enqueued for servicing by the memory (block 404). By way of example, the control logic 112 detects that the memory 118 is active with respect to servicing memory requests of the host processor 104 and/or at least one memory request is enqueued in pending memory request queues of memory controller 110. Responsive to this detection, the control logic 112 issues an engagement signal 124. In particular, the engagement signal 124 is provided to the voltage regulator 114, which connects the power supply 122 to the remainder of the memory PHY 116 via the gated connection 202. This causes the memory PHY 116 to exit the enhanced low power state 128 and enter an active state.

In addition, the engagement signal 124 is provided to the finite state machine 220, which issues restore signals 302 responsive to receiving the engagement signal 124. The restore signals 302 cause the registers 208 of the retention flops 214 to write the current state 206 of the data within the soft macro portion 210 of the memory PHY 116 from the retention cells 224 to the operation cells 222 after the power supply 122 is connected to the operation cells 222 via the gated connection 202. In addition, the restore signals 302 cause the current state 206 of the data within the hard macro portion 212 to be written from the registers 208 of the SRAM 216 to the hard macro portion 212 after the power supply 122 is connected to the hard macro portion 212 via the gated connection 202. This enables the enhanced low power state 128 to be exited with minimal latency and while preserving data integrity within the memory PHY 116.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102, host processor 104, the memory module 106, the core 108, the memory controller 110, the control logic 112, the voltage regulator 114, the memory PHY 116, the memory 118, the caches 120, the registers 208, the retention flops 214, the SRAM 216, and the finite state machine 220) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A device, comprising:
a host processor;
a memory; and
a memory physical layer configured to enter an enhanced low power state in which a power supply is disconnected from a portion of the memory physical layer while the memory is inactive with respect to servicing memory requests of the host processor.

2. The device of claim 1, wherein the memory physical layer is configured to enter the enhanced low power state responsive to no memory requests being serviced by the memory and no memory requests being enqueued for servicing by the memory.

3. The device of claim 1, wherein the memory physical layer is further configured to exit the enhanced low power state responsive to at least one memory request being serviced by the memory.

4. The device of claim 1, wherein the memory physical layer is configured to exit the enhanced low power state responsive to at least one memory request being enqueued for servicing by the memory.

5. The device of claim 1, wherein the power supply is disconnected from one or more input/output (I/O) interfaces of the memory physical layer while the memory physical layer operates in the enhanced low power state, thereby causing the memory to operate in a self-refresh mode.

6. The device of claim 1, wherein the memory physical layer includes registers storing a current state of data within the memory physical layer, and the power supply is connected to the registers while the memory physical layer operates in the enhanced low power state.

7. The device of claim 6, wherein one or more registers of the registers are implemented in retention flops each including a retention cell and an operation cell, and the power supply is connected to the retention cells and disconnected from the operation cells while the memory physical layer operates in the enhanced low power state.

8. The device of claim 7, wherein the memory physical layer is configured to issue one or more save signals causing the one or more registers to save the current state of the data to the retention cells prior to entering the enhanced low power state.

9. The device of claim 7, wherein the memory physical layer is configured to issue one or more restore signals causing the one or more registers to restore the current state of the data to the operation cells responsive to exiting the enhanced low power state.

10. The device of claim 6, wherein one or more registers of the registers are implemented in static random access memory of the memory physical layer, and the power supply is connected to the static random access memory while the memory physical layer operates in the enhanced low power state.

11. The device of claim 10, wherein the memory physical layer is configured to issue one or more save signals causing the one or more registers to save the current state of the data to the static random access memory prior to entering the enhanced low power state.

12. The device of claim 10, wherein the memory physical layer is configured to issue one or more restore signals causing the one or more registers to restore, responsive to exiting the enhanced low power state, the current state of the data to the portion of the memory physical layer to which the power supply is disconnected while the memory physical layer operates in the enhanced low power state.

13. A system, comprising:
a memory;
a memory physical layer; and
a host processor configured to issue a disengagement signal indicating that the memory is inactive with respect to servicing memory requests of the host processor, the disengagement signal causing the memory physical layer to enter an enhanced low power state in which a power supply is disconnected from a portion of the memory physical layer.

14. The system of claim 13, wherein the disengagement signal indicates that there are no memory requests being serviced by the memory and there are no memory requests enqueued for servicing by the memory.

15. The system of claim 13, wherein the host processor is further configured to issue an engagement signal indicating that at least one memory request is being serviced by the memory and/or at least one memory request is enqueued for servicing by the memory, the engagement signal causing the memory physical layer to exit the enhanced low power state.

16. The system of claim 13, wherein the memory physical layer includes registers storing a current state of data within the memory physical layer, and the power supply is connected to the registers while the memory physical layer operates in the enhanced low power state.

17. An apparatus, comprising:
a host processor;
a memory;
a memory physical layer; and
a voltage regulation circuitry configured to disconnect a power supply from a portion of the memory physical layer while the memory is inactive with respect to servicing memory requests of the host processor.

18. The apparatus of claim 17, wherein the voltage regulation circuitry is configured to disconnect the power supply from the portion of the memory responsive to no memory requests being serviced by the memory and no memory requests being enqueued for servicing by the memory.

19. The apparatus of claim 17, wherein the voltage regulation circuitry is configured to connect the power supply to the portion of the memory physical layer responsive to at least one memory request being serviced by the memory and/or at least one memory request being enqueued for servicing by the memory.

20. The apparatus of claim 17, wherein the memory physical layer includes registers storing a current state of data within the memory physical layer, and the power supply is connected to the registers while the power supply is disconnected from the portion of the memory physical layer.
